(19) United States
(12) Patent Application Publication
(10) Pub. No.: US 2020/0347718 A1
(43) Pub. Date: Nov. 5, 2020

(54) DETECTION AND MONITORING OF CORROSION INHIBITORS IN OILFIELD FLUIDS

(71) Applicant: Baker Hughes, a GE company, LLC, Houston, TX (US)

(72) Inventors: Sankaran Murugesan, Katy, TX (US); Prasad D. Dhulipala, Katy, TX (US); Zhengwei Liu, Houston, TX (US); Sunder Ramachandran, Sugar Land, TX (US)

(73) Assignee: Baker Hughes, a GE company, LLC, Houston, TX (US)

(21) Appl. No.: 16/863,717

(22) Filed: Apr. 30, 2020

Related U.S. Application Data
(60) Provisional application No. 62/843,173, filed on May 3, 2019.

(51) Int. Cl. E21B 47/00; E21B 41/02; C09K 8/54; G01N 21/65

(52) U.S. Cl. CPC E21B 47/006; E21B 41/02; C09K 2208/10; G01N 21/658; C09K 8/54

(57) ABSTRACT

This disclosure is directed to the use of a portable Surface Enhance Raman Spectroscopy method to detect, quantify, and/or monitor corrosion inhibitors that are present in fluids in a wide range of concentrations in order to manage corrosion treatment in oil and gas production and refining systems or other industrial systems and to reduce the amount of time spent in obtaining data that is reliable and useful for corrosion control.

### CROSS-REFERENCE TO RELATED APPLICATION

This application claims the benefit of Provisional Patent Application No. 62/843,173 filed May 3, 2019, which is incorporated by reference herein in its entirety.

### TECHNICAL FIELD

The present disclosure relates to methods and systems capable of detecting, quantifying, and/or monitoring corrosion inhibiting chemicals used to protect metal surfaces in oil and gas production and refining system that are contacted by oilfield fluids. More specifically, this disclosure is directed to the use of Surface Enhanced Raman Spectroscopy (“SERS”) to detect, quantify, and/or monitor corrosion inhibitor formulations, such as formulations comprising chemicals with thiol or sulfhydryl groups or nitrogen-containing compounds, that are present in highly ionic oilfield fluids in a wide range of concentrations in order to manage corrosion treatment in oil and gas production and refining systems.

### BACKGROUND

Accurate and reliable detection and monitoring of corrosion inhibitors in oilfield fluids is an important aspect of corrosion control in wells and pipelines used for the production and transport of production fluids. Chemical analysis of residual (i.e. low) concentrations of corrosion inhibitors is useful in helping to monitor efficiency of performance, adequacy of, and adjustment of treatment in protecting tubulars in production and pipeline systems.

Corrosion inhibitors are delicate blends of film formers, film enhancers, surfactants, demulsifiers, oxygen scavengers, etc. Many of the inhibitor components are nitrogen-based but there are also non-nitrogenous components which contain phosphorus, sulfur or oxygen. Corrosion inhibitor components commonly used in the oilfield industry include, but are not limited to, amides/imidazolines, salts of nitrogenous molecules with carboxylic acids and mercapto acids/alcohols, nitrogen quaternaries, polyoxyalkylated amines, amides and imidazolines, nitrogen heterocyclics, thiols, and alkylethoxyphosphates.

Several developments in the detection and monitoring of residual corrosion inhibitors in oilfield fluids have been published in recent years. The major techniques employed are based on ultraviolet spectroscopy (“UV”), chromatography, and mass spectroscopy techniques, such as gas chromatography-mass spectrometry (“GC-MS”), electrospray-mass spectrometry (“ES-MS”), and high performance liquid chromatography (“HPLC”) and Liquid Chromatography-Mass spectrometry (“LC-MS”). Mass spectrometry, for example, has the ability to provide high resolution molecular detail with high sensitivity when measuring corrosion inhibiting chemical analytes. However, most of these methods lack portability, requires tedious laboratory procedures located off-site, and/or lack the ability to provide accurate and reliable detection and monitoring when corrosion inhibiting chemicals are present in concentrations in the part per billion (“ppb”) range, when these chemicals are present in the midst of the strong interfering analytes, or when these chemicals are in production and oilfield fluids, which typically have high ionic strength.

Moreover, most of chemical corrosion analysis is dedicated to the detection and monitoring of quaternary amines or quaternary salts, film forming components in corrosion inhibitors, in aqueous-based oilfield fluids. There has not been much progress in the development of accurate and reliable methods or techniques for detection and monitoring the presence of other commonly used corrosion inhibiting chemicals, like sulfur-containing compounds, phosphorus-containing compounds, and oxygen-containing organic compounds. For the nitrogen-containing compounds, specifically, current analytical methods are not adequate to detect and measure these types of chemicals at low concentrations.

Thus, it is desirable to develop better and more accurate detection and monitoring of a wider range of corrosion inhibitor molecules that are present in corrosive oilfield environments in low (i.e. residual) concentrations. It is also desirable to develop detection methods that may also be performed in the field to reduce the amount of time spent to obtain data useful and reliable data for corrosion control and to reduce the health, safety, and environmental risk associated in shipping samples to centralized laboratories.

### SUMMARY

There is provided, in one form, a method for detecting and monitoring a corrosion inhibitor in a fluid comprising: preparing a sample of the fluid comprising a corrosion inhibitor; exposing the sample to a solution or substrate comprising a metal surface; placing the exposed sample into a portable Surface Enhanced Raman Spectroscopy (“SERS”) device; and obtaining data relating to the corrosion inhibitor from the portable SERS device.

In one non-limiting embodiment, the fluid sample is mixed or reaction with a reagent prior to exposing the fluid sample to a solution or substrate with a metal surface. In another non-limiting environment, the fluid has a concentration of corrosion inhibitor ranging from about 1 parts per billion to about 10000 parts per million and may be an aqueous oilfield fluid.

### BRIEF DESCRIPTION OF THE DRAWINGS

FIG. 1 is a graphic illustration showing the SERS device detection of 2-mercaptoethanol present in various concentrations in an oilfield brine.

FIG. 2 is a schematic illustration of the procedure for applying a solution containing EDTA to a synthetic brine sample for analysis in a SERS device.

FIG. 3 is a graphic illustration of the impact of addition of EDTA to samples of synthetic brine containing corrosion inhibitor in low concentration in SERS detection.

FIG. 4 contains two photographic illustrations of oilfield brine samples containing corrosion inhibitors and the effect of pH on precipitation of the solids in the samples.

FIG. 5 is a graphic illustration showing the SERS device detection of corrosion inhibitors in the oilfield brine samples shown in FIG. 3 having varying low pH levels.

FIG. 6 contains photographic illustrations of fluid samples containing a corrosion inhibitor 1 (“CI-1”) collected and analyzed in the field and fluid samples containing CI-1 collected in the field but shipped to a central lab.

### DETAILED DESCRIPTION

It has been discovered that a portable SERS device may be used to detect, quantify, and/or monitor corrosion inhibiting chemicals, such as thiols, quaternary amines, and the like, used to protect metal surfaces in oil and gas production and refining systems and other industrial systems that are contacted by fluids, which are often ionic in nature, to manage corrosion treatment in such systems, wherein the detection, quantification, and/or monitoring may be carried out in a variety of conditions, including when the corrosion inhibiting chemicals are present in the oilfield fluid in low (i.e. residual) concentrations.

As used herein, “oil and gas production and refining system” means a combination of technology, equipment, conduits, devices, and the facilities housing the foregoing that are used in the production and refining of energy sources recovered from subterranean reservoirs and geothermal wells. Much of the technology, equipment, conduits, and devices in such systems have metal surfaces that come into contact with various types of fluids. The types of metal surfaces found in oil and gas production and refining systems include, but are not limited to, an iron-containing surface, such as steel; carbon steel; an aluminum-containing surface; yellow metal surfaces, such as copper and copper alloys; and combinations thereof. It is these surfaces that are protected against corrosion by the corrosion inhibitors.

Oilfield fluid is defined herein to be any fluid that is carried by or flowing through conduits in an oil and gas production and refining system or other industrial system. In one non-limiting embodiment, the oilfield fluid may be an “aqueous oilfield fluid,” which, for purposes of this disclosure, is defined to mean a fluid carried by or flowing through conduits in a system in which water is the continuous phase or in which water represents more than 50% of the volume, such as, without limitation, production fluid, brine, seawater, refinery process fluid, utility water, and combinations thereof. Such fluids may also contain hydrocarbons. In another non-limiting embodiment, the oilfield fluid may be a fluid with high ionic strength. For purposes of this disclosure, “high ionic strength” is a function of measure of the concentration of ions in the oilfield fluid represented by the total dissolved solids (TDS) concentration. TDS concentration describes the level of presence of inorganic salts and small amounts of organic matter in an aqueous fluid, like an oilfield brine, which contains a large concentration of divalent cations and anions such as Ca²⁺, Ba²⁺ and SO₄²⁻. As a non-limiting example, a high ionic strength fluid may be defined to have a TDS concentration ranging from about 1,000 mg/L independently to about 500,000 mg/L independently, or alternatively a TDS concentration greater than 350,000 mg/L independently. The detection, quantification, and/or monitoring processes and systems described herein may also be used on fluids having low TDS concentrations between 0.1 mg/L independently to 1,000 mg/L independently, and fluids, such as high concentrated brines, which have TDS concentrations above 500,000 mg/L independently. As used herein with respect to a range, “independently” means that any threshold given may be used together with any other threshold given to provide a suitable alternative range.

The corrosion inhibitors that are applied to oilfield fluids to reduce or prevent corrosion upon the metal surfaces may be comprised of one or more chemicals with thiol or sulfhydryl groups. In one nonlimiting embodiment, the corrosion inhibitors may comprise 2 mercaptoethanol and/or dodecyl thiol. In another non-limiting embodiment, the corrosion inhibitor may be at least one nitrogen-containing compound such as, an amine, such a quaternary amine, an amide, imidazoline, alkyl pyridine, and combinations thereof.

The amount of the corrosion inhibitor or the amount of a particular component of the corrosion inhibitor present in the fluid varies or ranges depending on the needs of the system or fluid. Therefore, the concentration or amount of corrosion inhibitor or corrosion inhibitor component(s) may be present in the fluid being treated in a wide range of concentrations. In one non-limiting embodiment, corrosion inhibitors may be present in the system in concentrations as low as about 1 ppb independently to as high as about 10000 parts per million (“ppm”) independently; alternatively from about 1 ppb independently to about 500 ppm independently.

Detection, quantification, and/or monitoring of the presence, concentration, and/or performance of the corrosion inhibition chemicals of the kinds described herein may be accomplished using Surface Enhanced Raman Spectroscopy (“SERS”), in which a fluid sample containing an analyte is exposed to a solution or substrate comprising a metal surface and the sample is allowed to be adsorbed onto that surface. The metal surface may be “high surface area metal nanoparticles,” which are defined to be metal nanoparticles having a surface area ranging from 1 m²/g to 5,000 m²/g. The sample is then adsorbed upon the surface of the high surface area metal nanoparticles and the plasmonic properties of the metal nanoparticles enhance the Raman signals of the adsorbed analyte molecules allowing for detection and measurement of the analytes that may be present in the sample by a portable SERS device.

In one non-restrictive embodiment, the corrosion inhibitor chemical(s) present in a fluid, such as an oilfield brine comprising or solely containing a thiol at a concentration ranging from about 1 ppb to about 5000 ppm, may be detected, quantified, and/or monitored by preparing a sample of oilfield brine comprising the thiol. The step of preparing a sample involves extracting, by hand or by device, a small portion of the fluid containing a corrosion inhibitor sought to be analyzed. The volume of the sample may range from about 0.01 ml to 100 ml. The prepared sample is then exposed to a solution or substrate comprising metal nanoparticles that have a high surface area and are plasmonic. The metal nanoparticles may be, without limitation, gold nanoparticles, silver nanoparticles, titanium oxide nanoparticles, iron (III) oxide nanoparticles, tungsten (VI) oxide nanoparticles, zinc nanoparticles, and combinations thereof, and may be in the shape of a wire, a tube, and/or a sphere. In one embodiment, the metal nanoparticles may be functionalized, which means they may undergo the addition of specific functional groups to enhance their plasmonic properties. These functional groups include, but are not limited to, a cyano group, a carboxyl group, an amino group, a boronic acid group, an aza group, an ether group, a hydroxyl group, and combinations thereof. The functional groups be present in the functionalized metal nanoparticles in amount ranging from about 0.1 wt. % to about 60 wt. %, based on the total weight of the functionalized metal nanoparticles. In another non-limiting embodiment, the metal nanoparticles are not coated with silica.

After exposing the sample to a solution or substrate comprising metal nanoparticles, the exposed sample is then placed into a portable SERS device, which measures the Raman scattering of the chemicals in the sample. The scattering data produced by the SERS device is then used to measure the amount of the corrosion inhibitor in the fluid.

The measurement of the amount of corrosion inhibitor chemical(s) derived from the data generated by portable the SERS device may then be used to monitor the corrosion inhibiting chemical(s) within the oil and gas production and refining system or other industrial system and determine if the amount of corrosion inhibitor applied for treatment of metal surfaces should be adjusted.

In some cases, the fluid containing a corrosion inhibitor from which the sample is created may contain metal ions that precipitate and do not stay dissolved within the solution, especially in response to pH changes in the sample by the interference or introduction of other chemicals. The presence of functionalized gold nanoparticles, for example, may be useful in stabilizing or protecting the metal ions from dissolution and allowing for detection, quantification, and/or monitoring of low concentration corrosion inhibitor analytes in samples that comprise acidic mediums, e.g. fluids having a pH ranging from about 1 to about 7. Depending on the pH of the sample, the sample may be mixed or reacted with a reagent having a 0.01 molar to 20 molar concentration of an acid or a base before being analyzed by the SERS device. Useful acids include inorganic acids, such as hydrochloric acid, nitric acid, phosphoric acid, sulfuric acid, boric acid, hydrofluoric acid, hydrobromic acid, perchloric acid, hydroiodic acid, and/or organic acids, such as lactic acid, acetic acid, formic acid, citric acid, oxalic acid, uric acid, malic acid, tartaric acid. Bases that may be used include, but are not limited to, lithium hydroxide, sodium hydroxide, potassium hydroxide, rubidium hydroxide, cesium hydroxide, calcium hydroxide, strontium hydroxide, barium hydroxide, tetramethylammonium hydroxide, guanidine, pyridine, alkylamines, imidazole, benzimidazole, histidine, phosphazene bases, hydroxides of quaternary ammonium cations or some other organic cations, and combinations thereof. Alternatively or in addition to the acid or base reagent, a reagent containing a chelating agent in a molar concentration ranging from 0.01 to 50 may be mixed or reacted with the sample of fluid containing a corrosion inhibitor before it is analyzed on the SERS device to help stabilize and complex the metal ions to provide for detection, quantification, and/or monitoring of low concentration corrosion inhibitor analytes in high pH conditions, which typically create more aggregation and precipitation. The chelating agent may be selecting from a group consisting of ethylenediaminetetraacetic acid (EDTA), ethylenediamine, amino acids, dimercaptosuccinic acid, citric acid, nitrilotriacetic acid such as ethylenediaminetetraacetic acid (EDTA), ethylenediamine, amino acids, dimercaptosuccinic acid, citric acid, nitrilotriacetic acid, and combinations thereof. “High pH conditions” may be defined to include samples having a pH ranging from about 8 to about 13. The processes and systems for detection, quantifying, and/or monitoring of corrosion inhibitors in fluids described herein may also be performed on samples having a moderate pH of about 6 to about 8. In one non-restrictive embodiment, the reagent may be reacted or mixed with the fluid sample before exposing the fluid sample to a solution or substrate comprising a metal surface.

In a further non-limiting embodiment, an oilfield fluid being analyzed may additionally include primary, secondary, or tertiary amines and amino alcohols, which are typically present in produced water, that may interfere with the analysis of particular corrosion inhibition chemicals. It has been discovered that gold nanoparticles have an affinity towards sulfur-containing compounds, such as mercaptans, thiols and sulfides, which may help in detecting, quantifying, and/or monitoring sulfur-containing analytes even in the presence of such interfering chemicals.

The invention will be further described with respect to the following Examples, which are not meant to limit the invention, but rather to further illustrate the various embodiments.

### Example 1

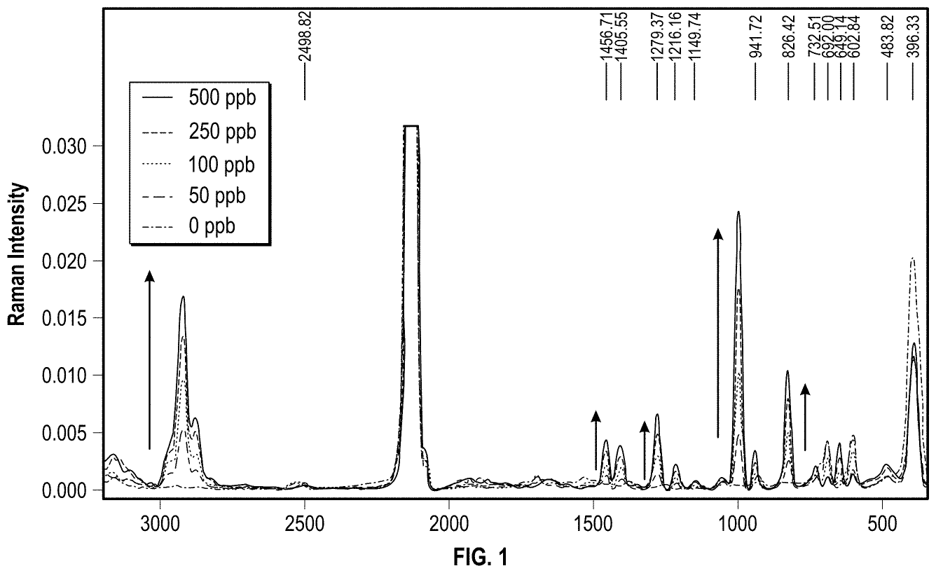

FIG. 1 is a graphic illustration showing the detection by a SERS device with gold nanoparticles of 2-mercaptoethanol (“2ME”), a corrosion inhibiting chemical, present in various concentrations in an oilfield brine.

The data in FIG. 1 indicates that 2ME can be detected in low concentrations (ppb level) in oilfield brine.

### Example 2

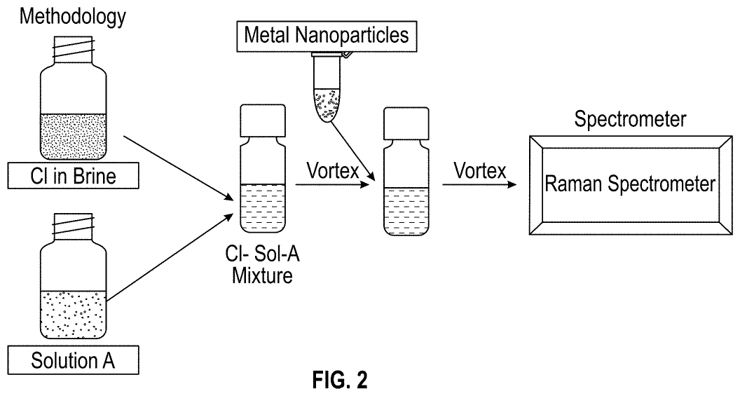

FIG. 2 is a schematic illustration of the procedure for applying a solution containing EDTA to a synthetic brine sample for analysis in a SERS device.

Solution A in FIG. 2 is solution comprising 40% EDTA with NaOH. This solution is mixed or reacted with a synthetic field brine to stabilize the ions present in this brine. The brine sample in this experiment has the following ions: Na⁺, K⁺, Mg²⁺, Ca²⁺, Fe²⁺, Sr²⁺ and Ba²⁺.

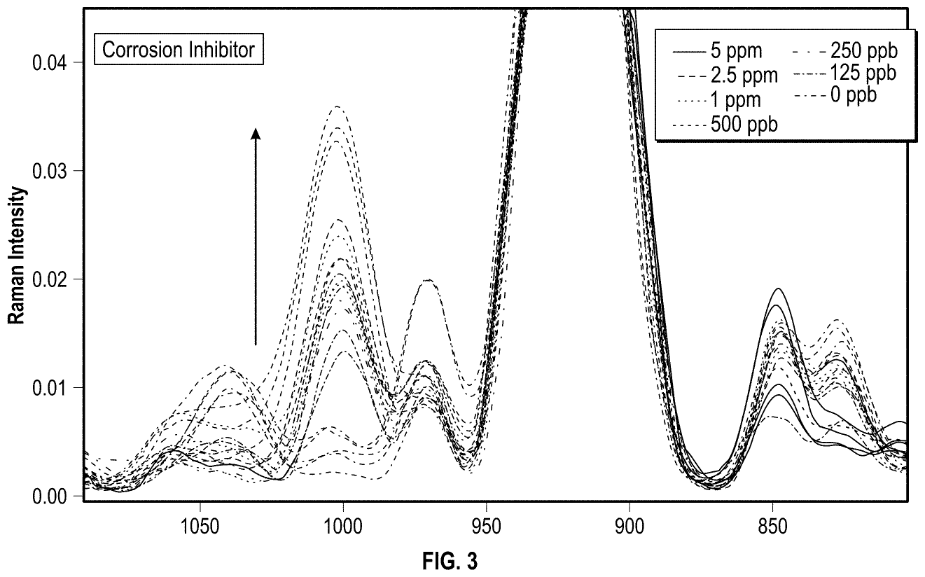

A separate test showed that, without EDTA, synthetic brine sample started to form a precipitate during addition of NaOH for SERS measurements. The graph in FIG. 3 shows the analysis of a commercialized oilfield chemical comprising EDTA as stabilizer and enhancer (“Corrosion Inhibitor”). The data presented indicates that the signals corresponding to EDTA do not interfere with the chemical analyzed and it is possible to detect chemicals in low concentrations (ppb).

### Example 3

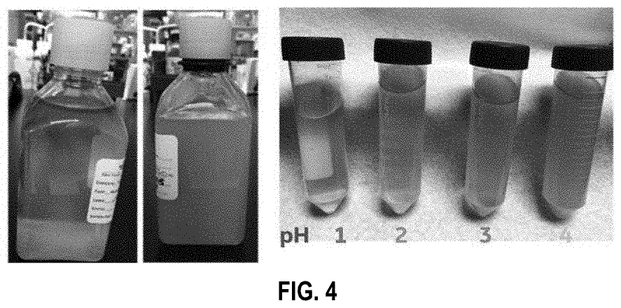

FIG. 4 contains two photographic illustrations of oilfield brine samples containing corrosion inhibitors and the effect of pH on precipitation of the solids in the samples.

The first photographic illustration in FIG. 4 shows an oilfield brine sample with production chemicals (corrosion inhibitors) after shipping the water sample from production site, which caused precipitation of sample due to presence of Fe. Analyzing the sample by filtering the residue leads to inconsistent results.

The second photographic illustration in FIG. 4 shows that at low pH of about 1 it is possible to dissolve all the precipitate until the sample becomes a clear liquid.

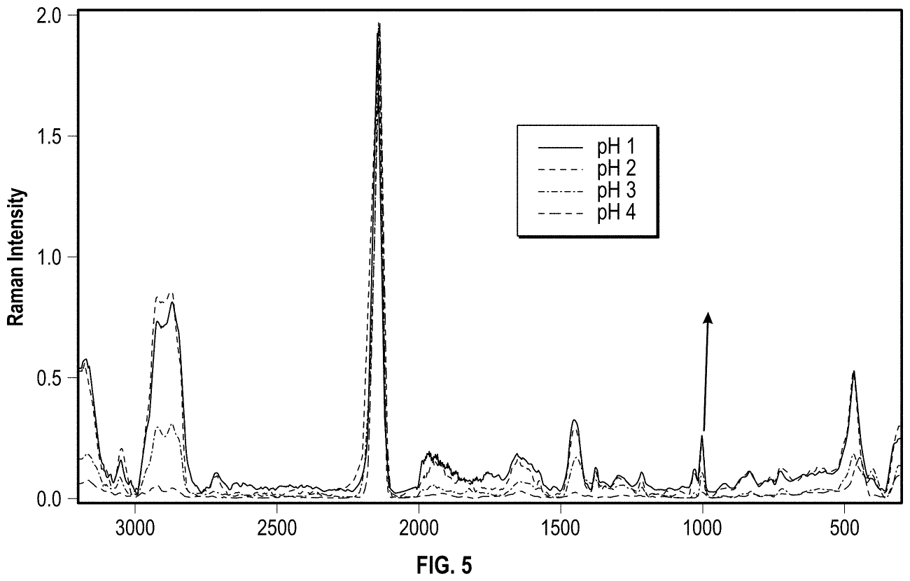

FIG. 5 is a graphic illustration showing the SERS device detection of corrosion inhibitors in the oilfield brine samples shown in FIG. 3 having varying low pH levels. From the analysis, it is clear that, at a pH of about 1, the intensity and resolution of the peaks were improved.

### Example 4

In another set of evaluations, corrosion inhibitor-treated field samples were collected at site and either (1) analyzed in the field by a portable SERS device within a few hours of sample collection or (2) shipped to a centralized lab for analysis.

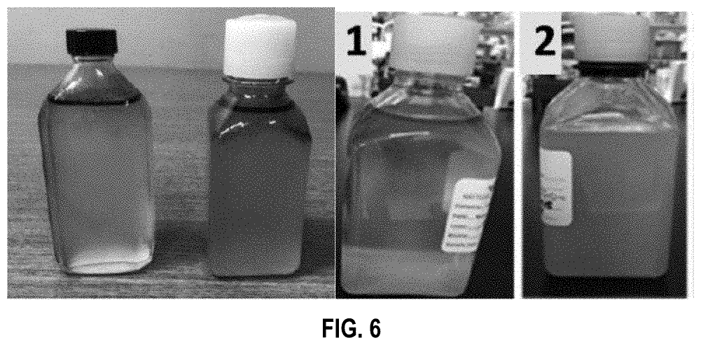

As shown in the photographic comparison in FIG. 6, the samples collected and analyzed at the site showed different characteristics from the samples shipped to the central lab. The samples collected at the field and analyzed at the field were translucent but relatively homogeneous in nature, showing no solid settling or precipitation. In contrast, the shipped samples showed separation into different phases and precipitation (see right hand side photograph in FIG. 6).

Because the shipped samples showed precipitation, they were rejuvenated with acid to make them homogenous. The acidization of the shipped samples may lead to spurious data and loss of product. The SERS analysis performed on the samples in FIG. 6 showed differences in the concentration of CI-1 between samples analyzed at the field versus the shipped samples. Samples shipped to the lab and rejuvenated with acid showed a concentration 365 ppm of CI-1, whereas fresh samples showed a concentration of 800 ppm, which is closer to the injection rate of about 1000 ppm CI-1 at that site. It will be appreciated that the loss of corrosion inhibitor in the shipped samples may be due to precipitation and the rejuvenation process.

The portable SERS detection method disclosed herein was applied to more field samples containing other corrosion inhibitors, corrosion inhibitor 2 (“CI-2”) and corrosion inhibitor 3 (“CI-3”), collected at different time intervals to measure the corrosion inhibitor concentrations and these measurements were compared to concentration measurements of the same field samples using an incumbent method involving a more tedious multistep sample preparation and analyzing procedure than that shown in FIG. 2. Tables 1 and 2 show the results of these evaluations.

TABLE 1
Measurements of CI-2 concentrations
Concentration of Corrosion Inhibitor 2 (ppm)

| | Collection month | | | | | | | | | | |
|---|---|---|---|---|---|---|---|---|---|---|---|
| | February | | | | April | | | June | | | |
| Sample ID | A | B | C | D | B | C | D | A | B | C | D |
| SERS | 15 | 91 | 200 | 87 | 24 | 225 | 1610 | 85 | 23 | 86 | 70 |
| Method | | | | | | | | | | | |
| Incumbent | <10 | <10 | <10 | <10 | ND | <25 | 27.6 | <10 | <10 | 25.5 | <10 |
| Method | | | | | | | | | | | |

TABLE 2
Measurements of CI-3 concentrations
Concentration of Corrosion Inhibitor 3 (ppm)

| Sample ID | 1 | 2 | 3 | 4 | 5 | 6 | 7 | 8 | 9 | 10 |
|---|---|---|---|---|---|---|---|---|---|---|
| SERS | 15.73 | 120.31 | 24.31 | 52.48 | 26.22 | 93.16 | 22.89 | 30.46 | 13.14 | 16.85 |
| Method | | | | | | | | | | |
| Incumbent | 16.9 | 11.6 | 6.75 | 85.4 | <5 | 32.7 | 15.7 | 26.2 | <5 | 44.5 |
| Method | | | | | | | | | | |

The data in Tables 1 and 2 shows that the portable SERS device detection method may exhibit better sensitivity than the incumbent method. However, it is noted that these two methods are based on different corrosion actives. The incumbent analysis method might be affected by sample age and thus better handling and preservation of corrosion inhibitor residues in the fluid samples may be of help.

Overall, the data shows that the portable SERS-based method to detect and measure the corrosion inhibitor residual in a relatively quick time frame was reliable and provided better concentration-sensitive measurements than the incumbent method, indicating the need for a field-based analytical method to estimate accurate concentrations without the sample undergoing changes during shipping can be met by the portable SERS-based method disclosed herein.

In the foregoing specification, the invention has been described with reference to specific embodiments thereof. However, it will be evident that various modifications and changes can be made thereto without departing from the broader spirit or scope of the invention as set forth in the appended claims. Accordingly, the specification is to be regarded in an illustrative rather than a restrictive sense. For example, oilfield fluids, corrosion inhibitors, chemicals, SERS devices and surfaces, concentrations, pH levels, metal surfaces, equipment, and devices falling within the claimed parameters, but not specifically identified or tried in a particular composition or method, are expected to be within the scope of this invention.

The present invention may suitably comprise, consist or consist essentially of the elements disclosed and may be practiced in the absence of an element disclosed or not disclosed.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “about” in reference to a given parameter is inclusive of the stated value and has the meaning dictated by the context (e.g., it includes the degree of error associated with measurement of the given parameter).

What is claimed is:

1. A method for detecting and monitoring a corrosion inhibitor in a fluid, the method comprising:
preparing a sample of a fluid comprising a corrosion inhibitor;
exposing the sample to a solution or substrate comprising a metal surface to form an exposed sample;
placing the exposed sample in a portable Surface Enhanced Raman Spectroscopy (“SERS”) device; and
obtaining data relating to the corrosion inhibitor from the portable SERS device.

2. The method of claim 1, wherein the fluid is an aqueous oilfield fluid.

3. The method of claim 2, wherein the fluid is an aqueous refinery process fluid.

4. The method of claim 2, wherein the fluid is an aqueous utility water.

5. The method of claim 2, wherein the concentration of the corrosion inhibitor in the aqueous oilfield fluid ranges from about 1 parts per billion to about 500 parts per million.

6. The method of claim 1, wherein the corrosion inhibitor is comprised of one or more chemicals with thiol or sulfhydryl groups.

7. The method of claim 6, wherein the corrosion inhibitor is a thiol.

8. The method of claim 7, wherein the corrosion inhibitor is selected from a group consisting of 2-mercaptoethanol, dodecyl thiol, and combinations thereof.

9. The method of claim 1, wherein the data relating to the corrosion inhibitor is selected from the group consisting of the amount of the corrosion inhibitor in the fluid, the behavior of the molecule making up the corrosion inhibitor, and combinations thereof.

10. The method of claim 1, further comprising adjusting the amount of corrosion inhibitor applied for treatment of metal surfaces within an oil production system or oil refining system.

11. The method of claim 1, wherein the corrosion inhibitor comprises at least one nitrogen-containing compound selected from a group consisting of an amine, an amide, alkyl pyridine, imidazoline, and combinations thereof.

12. The method of claim 1, wherein the metal surface comprises metal nanoparticles.

13. The method of claim 12, wherein the metal nanoparticles are functionalized.

14. the method of claim 12, wherein the metal nanoparticles are selected from a group consisting of gold nanoparticles, silver nanoparticles, titanium oxide nanoparticles, iron (III) oxide nanoparticles, tungsten (VI) oxide nanoparticles, zinc nanoparticles, and combinations thereof.

15. The method of claim 1, wherein the fluid sample is reacted or mixed with a reagent before exposing the fluid sample onto the metal surface.

16. The method of claim 15, wherein the reagent is selected from a group consisting of an aqueous acid, an aqueous base, a chelating agent, and combinations thereof.

17. The method of claim 1, wherein the concentration of the corrosion inhibitor in the fluid ranges from about 1 parts per billion to about 10000 parts per million.

18. The method of claim 1, wherein the fluid has a total dissolved solids concentration ranging from about 0.1 mg/L to about 500,000 mg/L.

19. The method of claim 1, wherein the fluid has a total dissolved solids concentration greater than 500,000 mg/L.

20. The method of claim 12, wherein the metal nanoparticles are not coated with silica.
